(19) United States
(12) Patent Application Publication
(10) Pub. No.: US 2011/0089885 A1
(43) Pub. Date: Apr. 21, 2011

(54) SWITCHED USB SOLAR CHARGING PORT

(76) Inventors: Upton Beall Bowden, Canton, MI (US); Robert Bruno Bucciarelli, Plymouth, MI (US); Dale O. Cramer, Royal Oak, MI (US)

(21) Appl. No.: 12/582,177

(22) Filed: Oct. 20, 2009

(51) Int. Cl. H02J 7/00

(52) U.S. Cl. 320/101; 307/80

(57) ABSTRACT

A charging system for a vehicle includes a primary energy source, a secondary energy source, a switching circuit in electrical communication with the primary energy source and the secondary energy source, and a charging port to provide electrical communication between the switching circuit and an electrical device, wherein the switching circuit selectively controls an electrical current flowing from the primary energy source and the secondary energy to the electrical device based upon a state of the vehicle.

### FIELD OF THE INVENTION

The present invention is related generally to a solar cell. In particular, the invention is directed to a switched charging system for a vehicle and a method for charging a portable electronic device.

### BACKGROUND OF THE INVENTION

A portable electronic device (e.g. a cell phone, a Portable Navigation Device (PND), an iPOD® device, a digital camera) typically includes a power source that requires charging. Most vehicles are equipped with at least one 12V DC power point. The consumer can use a range of aftermarket 12V DC converters and adapters to charge or power the portable electronic device.

The 12V DC power point is typically unpowered when the associated vehicle is switched off or in an “OFF” state, thereby reducing the ability to charge and power the portable electronic devices. In some vehicles, the 12V power point is powered when the vehicle is off. However, charging the portable electronic device when the vehicle is turned off can drain the car battery. Accordingly, when charging over a prolonged period of time a no start condition can occur.

Aftermarket solar charging products exist, but integration of solar cells into an interior of the vehicle is new and developing. Automotive integration of solar chargers currently focuses on trickle charging the vehicle battery.

It would be desirable to develop a switched charging system for a vehicle and a method for charging a portable electronic device, wherein the system and method minimize a drain on a battery of a vehicle when the vehicle is turned off.

### SUMMARY OF THE INVENTION

Concordant and consistent with the present invention, a switched charging system for a vehicle and a method for charging a portable electronic device, wherein the system and method minimize a drain on a battery of a vehicle when the vehicle is turned off, has surprisingly been discovered.

In one embodiment, a charging system for a vehicle comprises: a primary energy source in electrical communication with an electrical architecture of the vehicle; a secondary energy source disposed on the vehicle; a switching circuit in electrical communication with the primary energy source and the secondary energy source; and a charging port to provide electrical communication between the switching circuit and an electrical device, wherein the switching circuit electively controls an electrical current flowing from the primary energy source and the secondary energy to the electrical device based upon a state of the vehicle.

In another embodiment, a charging system for a vehicle comprises: a battery in electrical communication with an electrical architecture of the vehicle; a solar energy device disposed on the vehicle; a switching circuit in electrical communication with the battery and the solar energy device; and a charging port to provide electrical communication with the switching circuit and an electrical device, wherein the switching circuit selectively controls an electrical current flowing from the battery and the solar energy device to the electrical device based upon a state of the vehicle.

The invention also provides methods for charging a portable electronic device.

One method comprises the steps of: providing a primary energy source in electrical communication with an electrical architecture of a vehicle; providing a sensing module to determine a state of the vehicle; providing a switching circuit in electrical communication with the primary energy source, the sensing module, and a secondary energy source; and providing a charging port to provide electrical communication between the switching circuit and an electrical device, wherein the switching circuit selectively controls an electrical current flowing from the primary energy source and the secondary energy to the electrical device based upon the state of the vehicle.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a fragmentary perspective view of an interior of a vehicle including a charging system according to an embodiment of the present invention; and

FIG. 2 is a schematic block diagram of the charging system of FIG. 1.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

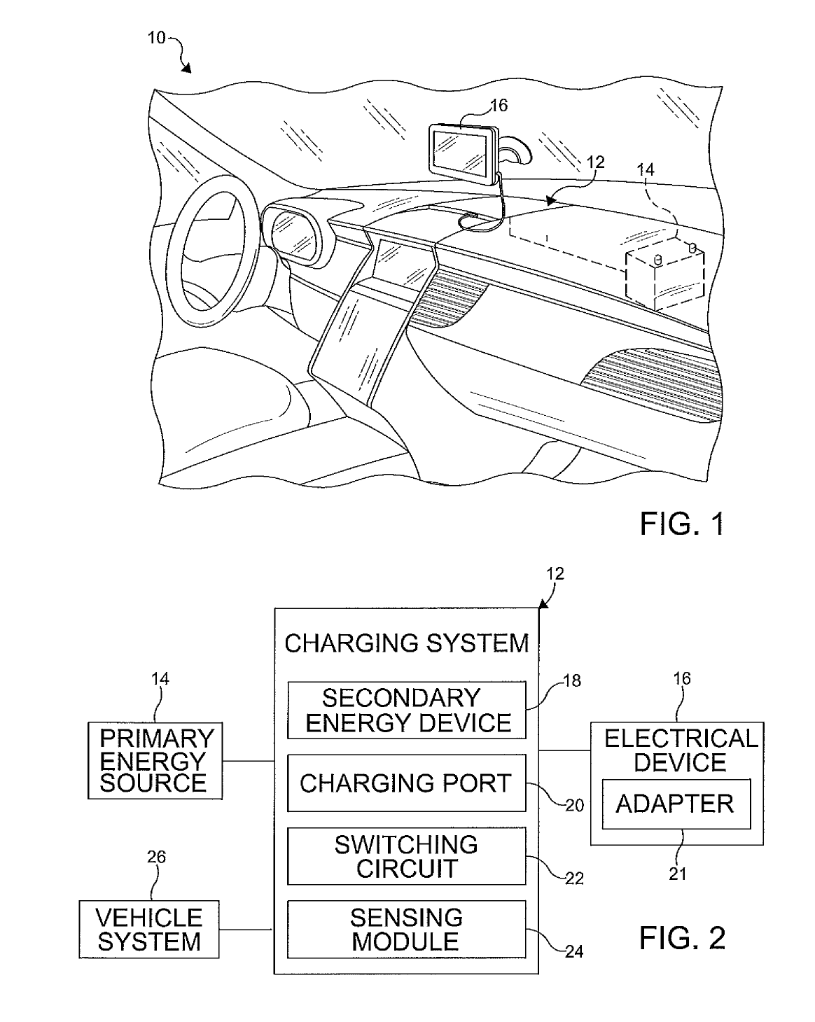

FIG. 1 shows an interior of a vehicle 10 including a switched charging system 12 according to an embodiment of the present invention. The charging system 12 is integrated with an existing electrical architecture in the vehicle 10 and in electrical communication with a primary energy source 14 such as an onboard battery of the vehicle 10. It is understood that the primary energy source 14 may be any electrical source in the vehicle 10. The charging system 12 is adapted to route an electrical current to an electrical device 16 for powering or charging the electrical device 16. The electrical device may be any electrical device such as a portable consumer electronic device, for example.

As more clearly shown in FIG. 2, the charging system 12 includes a secondary energy source 18, a charging port 20, and a switching circuit 22. As shown, the charging system 12 is disposed on a dashboard of the vehicle 10. It is understood that the components of the charging system 12 may be disposed in any location throughout the vehicle 10. It is further understood that any number of components of the charging systems 12 may be used in the vehicle 10.

The secondary energy source 18 is a solar energy device such as a solar cell, a solar array, or a solar panel, for example. The secondary energy source 18 is shown disposed on a front dashboard of the vehicle 10. As a non-limiting example, the secondary energy source 18 may be integrated in automotive glass (e.g. roof or windows). As a further example, the secondary energy source 18 may be integrated on the top of an instrument panel of the vehicle 10 or a rear deck lid behind a rear seat of the vehicle 10. It is understood that the secondary energy source 18 may be any energy source such as a renewable energy device.

The charging port 20 is in electrical communication with the switching circuit 22 and provides an interface between the switching circuit 22 and the electrical device 16. As shown, the charging port 20 is a universal serial bus port integrated with a housing of the secondary energy source 18. However, other ports and power points may be used. For example, a 12 volt power point similar to a conventional vehicle integrated cigarette lighter ports may be used. It is understood that the charging port 20 may be positioned in any location. It is further understood that the electrical device 16 may include an adapter 21 or connector to electrically couple the electrical device 16 to the charging port 20.

The switching circuit 22 is in electrical communication with the primary energy source 14 and a secondary energy source 18 and is adapted to route an electrical current to the charging port 20 for powering or charging the electrical device 16 coupled thereto. The switching circuit 22 also includes a sensing module 24 in electrical communication with a vehicle system 26 to sense a state of the vehicle 10. For example, the sensing module 24 determines whether the vehicle 10 is in an “ON” state or an “OFF” state as sensed by an ignition system or an electronic control module of the vehicle 10. It is understood that the switching circuit 22 may selectively control the routing of the electrical current based upon any state of the vehicle 10. The sensing module 24 may intercommunicate with any system or component of the vehicle 10 to determine a state thereof. It is further understood that the switching circuit 22 may include any electrical configuration to selectively control a path of the electrical current flowing to the charging port 20.

In operation, when the vehicle 10 is in an “ON” state electrical power is supplied to the electrical device 16 by the primary energy source 14 through the charging port 20. When the vehicle 10 is in an “OFF” state, the switching circuit 22 disconnects the primary energy source 14 from the charging port 20 and routes electrical power from the secondary energy source 18 to the charging port 20. It is understood that as long as the second energy source 18 has available energy, an electric current can be supplied to the charging port 20.

The charging system 10 minimizes a parasitic drain of the primary energy source 14 and a potential no start condition from changing portable devices when the vehicle 10 is in an “OFF” state.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A charging system for a vehicle comprising:
a primary energy source in electrical communication with an electrical architecture of the vehicle;
a secondary energy source disposed on the vehicle;
a switching circuit in electrical communication with the primary energy source and the secondary energy source; and
a charging port to provide electrical communication between the switching circuit and an electrical device, wherein the switching circuit selectively controls an electrical current flowing from the primary energy source and the secondary energy to the electrical device based upon a state of the vehicle.

2. The charging system according to claim 1, wherein the primary energy source is an onboard battery of the vehicle.

3. The charging system according to claim 1, wherein the secondary energy source is a solar energy device.

4. The charging system according to claim 1, wherein the charging port is a universal serial bus.

5. The charging system according to claim 1, wherein the electrical device is a portable consumer electronic device.

6. The charging system according to claim 1, wherein the switching circuit causes the primary energy source to provide electrical current to the electrical device during an “ON” state of the vehicle.

7. The charging system according to claim 1, wherein the switching circuit causes the secondary energy source to provide electrical current to the electrical device during an “OFF” state of the vehicle.

8. The charging system according to claim 1, further comprising a sensing module in electrical communication with the switching circuit and a vehicle system to determine the state of the vehicle and control the switching circuit based upon the state of the vehicle.

9. A charging system for a vehicle comprising:
a battery in electrical communication with an electrical architecture of the vehicle;
a solar energy device disposed on the vehicle;
a switching circuit in electrical communication with the battery and the solar energy device; and
a charging port to provide electrical communication with the switching circuit and an electrical device, wherein the switching circuit selectively controls an electrical current flowing from the battery and the solar energy device to the electrical device based upon a state of the vehicle.

10. The charging system according to claim 9, wherein the solar energy device is disposed in an interior of the vehicle.

11. The charging system according to claim 9, wherein the solar energy device is integrated into a window portion of the vehicle.

12. The charging system according to claim 9, wherein the charging port is a universal serial bus.

13. The charging system according to claim 9, wherein the electrical device is a portable consumer electronic device.

14. The charging system according to claim 9, wherein the switching circuit causes the battery to provide electrical current to the electrical device during an “ON” state of the vehicle.

15. The charging system according to claim 9, wherein the switching circuit causes the solar energy device to provide electrical current to the electrical device during an “OFF” state of the vehicle.

16. The charging system according to claim 9, further comprising a sensing module in electrical communication with the switching circuit and a vehicle system to determine the state of the vehicle and control the switching circuit based upon the state of the vehicle.

17. A method for charging a portable electronic device, the method comprising the steps of:
providing a primary energy source in electrical communication with an electrical architecture of a vehicle;
providing a sensing module to determine a state of the vehicle;
providing a switching circuit in electrical communication with the primary energy source, the sensing module, and a secondary energy source; and
providing a charging port to provide electrical communication between the switching circuit and an electrical device, wherein the switching circuit selectively controls an electrical current flowing from the primary energy source and the secondary energy to the electrical device based upon the state of the vehicle.

18. The method according to claim 17, wherein the secondary energy source is a solar energy device disposed in an interior of the vehicle.

19. The method according to claim 17, wherein the switching circuit causes the primary energy source provides electrical current to the electrical device during an “ON” state of the vehicle.

20. The method according to claim 17, wherein the switching circuit causes the secondary energy source provides electrical current to the electrical device during an “OFF” state of the vehicle.
